(19) United States
(12) Patent Application Publication
(10) Pub. No.: US 2008/0212978 A1
(43) Pub. Date: Sep. 4, 2008

(54) Optical Pulse Regenerator

(75) Inventors: Sonia Boscolo, Birmingham (GB); Sergei Turitsyn, Birmingham (GB)

Correspondence Address: DARBY & DARBY P.C., P.O. BOX 770, Church Street Station, New York, NY, 10008-0770, US

(73) Assignee: Aston University, Birmingham (GB)

(21) Appl. No.: 10/597,465

(22) PCT Filed: Feb. 3, 2005
(86) PCT No.: PCT/GB2005/000362

§ 371 Date: Apr. 27, 2007

(30) Foreign Application Priority Data
Feb. 3, 2004 (GB) 0402344.6

(51) Int. Cl. H04B 10/17

(52) U.S. Cl. 398/175

(57) ABSTRACT

An optical pulse regenerator comprising means for broadening the temporal widths and flattening the centre portions of an optical pulse in optical communication using a saturable absorber such as, an unbalanced optical interferometer, and with an optical amplifier.

This invention relates to an optical pulse regenerator in particular, but not exclusively, for use in optical fibre communication systems employing return-to-zero (RZ) optical pulses. The invention also relates to an optical pulse regenerating component within an optical RZ receiver and to an optical pulse shaper that transfers RZ pulses to non-return-to-zero (NRZ)-like pulses. The invention particularly relates to regenerators that offer 2R regeneration, that is reamplification and reshaping, and phase margin improvement.

With known optical fibre communication systems, whenever an optical data signal, such as one comprising RZ pulses, is generated, transmitted, or processed, the quality of the signal deteriorates. There are three main factors that contribute to the deterioration of the signal quality: firstly amplitude noise, that consists of fluctuation of the amplitude of the main signals and/or growth of noise and radiative background in the zero bit slots, secondly distortion of the pulse shape, and thirdly timing jitter, a term used to mean the fluctuation of the pulse position in time. The main causes of these three degrading factors are usually non-linear interactions between propagating pulses in a single channel and/or in different wavelength-division multiplexed channels, noise introduced from optical amplifiers in the system, and detrimental effects introduced by additional elements in the system. The deterioration of the signal quality generally increases with the transmission distance and/or with the number of processes (switching, demultiplexing etc.) made with the optical data of pulses.

It is known to mitigate degradation of the signal, by using one or more regenerators within the system. The purpose of the regenerators is to restore the quality of the signal. Optoelectronic regenerators are known and also all-optical regenerators. All-optical regenerators could potentially provide high-speed and multichannel operation. It is also known to provide both so called 2R regenerators which can reamplify and reshape the signal pulses and 3R regenerators which also provide retiming.

Patent Application WO 02/056506 describes the use of an unbalanced non-linear optical loop mirror (NOLM) along with a section of dispersion-managed optical fibre transmission line in optical communication as an optical pulse regenerating transmission line element. The unbalanced NOLM in this instance acts as a saturable absorber filtering out low-intensity noise and dispersive waves from higher-power signals. This allows for restoration of the pulse amplitude and shape. Also, owing to its switching characteristic the NOLM can provide negative feedback control of the amplitude of pulses, which enables stabilisation of amplitude fluctuations. However, in such known optical pulse regenerating transmission lines problems of timing jitter are not directly improved or aided by the NOLM because the NOLM is insensitive to pulse position in time. Consequently such systems are of more limited use when timing jitter is a major or even the prime limiting factor.

It is also known to use the effect of Kerr non-linearity in a normal dispersion (that is negative dispersion coefficient measured in ps/(nm km)) fibre (NDF) to reduce the effect of timing jitter at an optical RZ receiver. However, such a technique is of more limited use when amplitude noise and pulse distortion are also major causes of signal deterioration.

According to a first aspect of the invention there is provided an optical pulse regenerator comprising means for broadening the temporal widths and flattening the centre portions of optical pulses in optical communication with a saturable absorber such as an unbalanced optical interferometer, and with an optical amplifier.

According to a further aspect of the invention there is provided an optical pulse regenerating component for incorporation into an optical return-to-zero receiver. The optical pulse regenerating component is an optical pulse regenerator according to the first aspect of the invention.

According to a further aspect of the invention there is provided an optical pulse shaper that transfer return-to-zero optical pulses to non-return-to-zero-like pulses. The optical pulse shaper is an optical pulse regenerator according to the first aspect of the invention.

Preferably the means for broadening the temporal widths and flattening the centre portions of optical pulses comprises a section of optical fibre having a negative dispersion coefficient, that is a section of normal dispersion fibre. Beneficially for a defined amount of pulse amplification by the optical amplifier, the length of the normal dispersion fibre providing a suitable power level at the fibre output can be determined by the trade off between the effects of dispersion, non linearity and attenuation of the fibre. Preferably, the unbalanced interferometer can be a Sagnac interferometer and preferably a fibre optic Sagnac interferometer. The interferometer may be a non-linear loop mirror which might comprise a 2×2 optical coupler, a first port on one side of the coupler forming the input to the non-linear optical loop mirror, the second port on the one side forming the output to the non-linear optical loop mirror, and the ports on the other side of the coupler being connected together by a section of optical waveguide, to form a waveguide loop. The optical coupler can be a fibre optic coupler or a semiconductor waveguide device and the optical waveguide comprises a section of optical fibre and/or a section of semiconductor waveguides.

Further, the regenerator can comprise a non-linear loop mirror which is an absorption non-linear loop mirror type, comprising an absorption element asymmetrically located within the fibre loop or an amplifying non-linear loop mirror, comprising an optical amplifier asymmetrically located within the fibre loop or a dispersion unbalanced non-linear loop mirror, or an unbalanced coupler non-linear loop mirror. Preferably the non-linear loop mirror operates within a region of its switching curve in which the output power of the non-linear loop mirror is substantially stable against small changes in the output power from the means for pulse broadening and flattening. Preferably, the non-linear loop mirror operates in the region just after the first peak in its switching curves. Additionally, the optical amplifier preferably adjusts the pulse power to a suitable level for input to the saturable absorber such as just after the first peak of its switching curve of the non-linear loop mirror. The length of the loop is preferably determined in terms of the input power to the non-linear loop mirror. Preferably, the non-linear loop mirror fibre loop is a loop of dispersion-shifted fibre. The optical amplifier is preferably a lumped erbium-doped fibre amplifier or a distributed Raman amplifier. In the latter case the normal dispersion fibre means for pulse broadening and flattening is preferably used as the amplifying medium. Preferably, the distributed Raman fibre amplifier is bi-directionally pumped by a forward pump and a backward pump, or the pumping is realised in a single direction, either co-directionally with the propagating signal or counter-directionally and accordingly can comprise one pump.

Beneficially, a regenerator is provided which combines the intensity filtering action of a saturable absorber, such as non-linear loop mirror, for achieving 2R regeneration of an optical signal with broadening of the temporal widths and flattening of the centre portions of optical pulses, such as produced by dispersion and non-linearity in a normal dispersion fibre, for improvement of the signal phase margin, and preferably wherein application in optical communication provides both suppression of noise and radiative background in the zero time slots of an optical signal and reduction of the amplitude jitter and reduction of the impact of timing jitter without increasing the intersymbol interference. Beneficially, such a regenerator can be used in optical transmission systems such as a transmission system employing a single channel optical data signal or wavelength-division multiplexed data signals. Beneficially, such a regenerator is applied in optical transmission systems after signal demultiplexing.

Beneficially, an optical pulse regenerating component is provided with an optical return-to-zero receiver having the features of the regenerator according to the invention in any of the preceding paragraphs. Beneficially such a component can be used for improving the signal quality before detection.

Beneficially, an optical pulse shaper is provided for transferring return-to-zero optical pulses to non-return-to-zero-like pulses having the features of the regenerator according to the invention of any preceding paragraph. Beneficially, such a shaper preferably provides that the transfer of return-to-zero pulses to non-return-to-zero-like pulses occurs through broadening of the temporal widths and flattening of the centre portions of pulses such as produced by dispersion and non-linearity in a normal dispersion fibre. Preferably, the shaper produces non-return-to-zero-like pulses having a rectangular-like temporal profile or a parabolic temporal profile.

Preferably the regenerator comprises components in a housing of an optical pulse regenerating unit. The regenerator and/or components of the housing may have an overall negative average dispersion coefficient and/or the optical fibre, outside of the saturable absorber has a near constant negative dispersion.

According to a further aspect of the invention there is provided the use of an unbalanced interferometer and a fibre with a negative dispersion coefficient to reduce effects of pulse distortion and amplitude noise and timing jitter.

According to a further aspect of the invention there is provided a method of regenerating a signal of optical pulses comprising the steps of; amplifying the pulse power, transmitting the signal through a section of fibre with negative dispersion coefficient to broaden the widths and flatten the centres of the pulses through dispersion and Kerr non-linearity and transmitting the amplified broadened and flattened signal through a saturable absorber such as an unbalanced NOLM to reduce pulse distortion and amplitude noise.

Embodiments of the present invention will now be described in detail, by way of example only, with reference to the accompanying drawings:

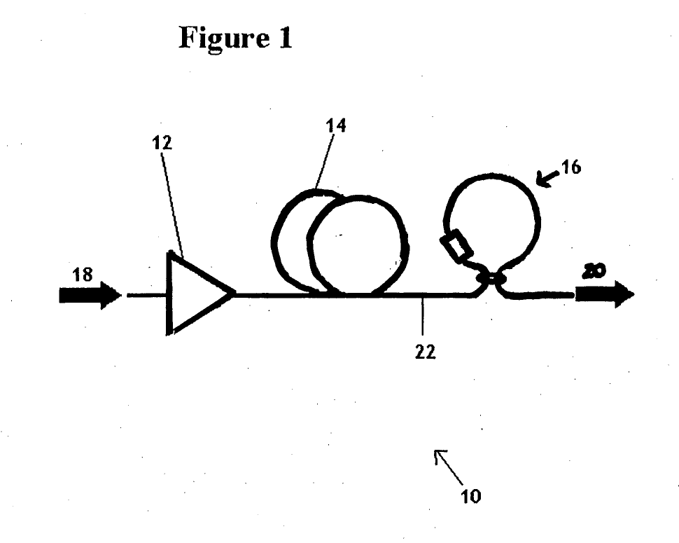

FIG. 1 is a schematic representation of an optical pulse regenerator according to the invention;

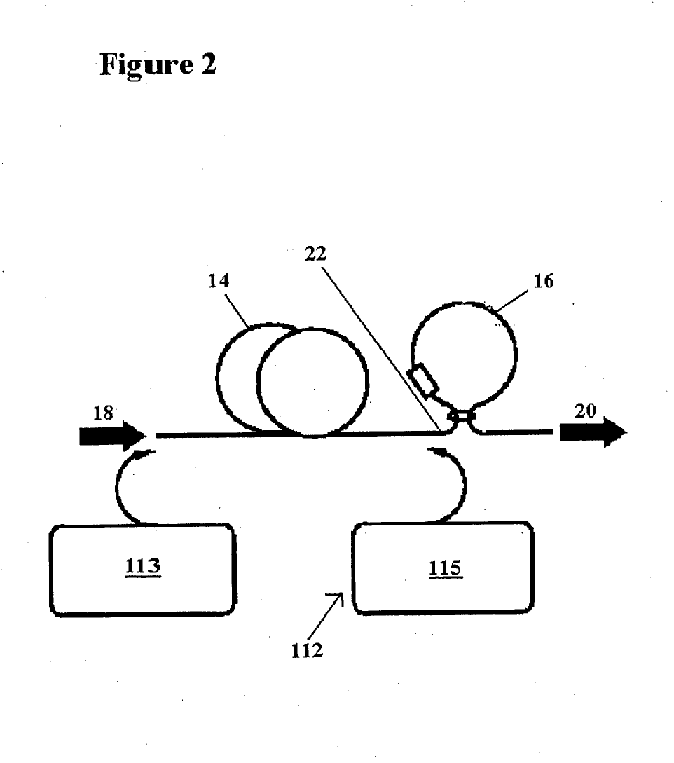

FIG. 2 is a schematic representation of a second embodiment of optical pulse regenerator according to the invention;

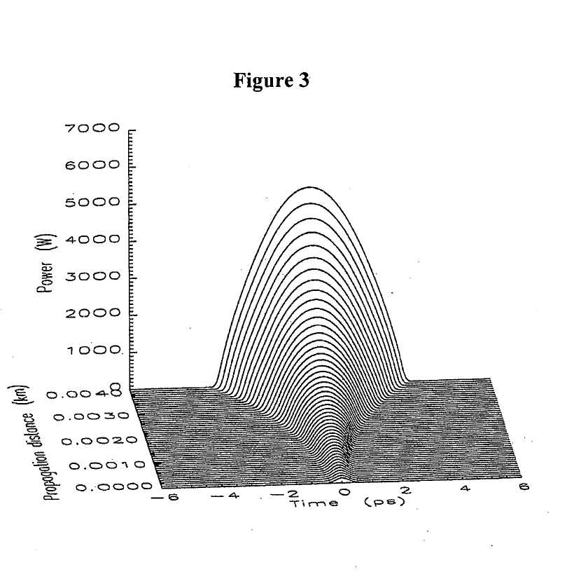

FIG. 3 is a graph illustrating the generation of a parabolic optical pulse from a distributed Raman fibre amplifier suitable for use in the optical pulse regenerator of FIG. 2;

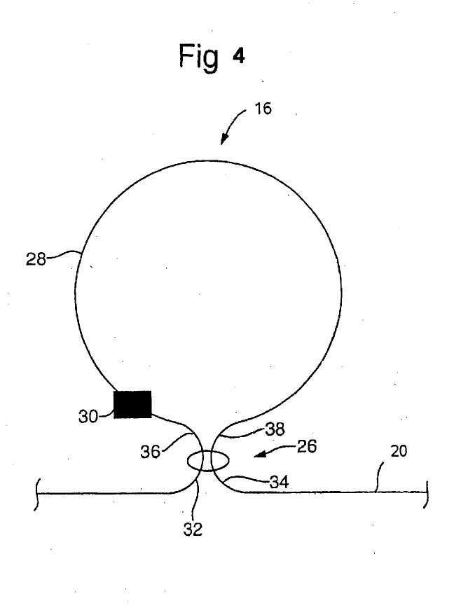

FIG. 4 is an enlarged schematic representation of an optical fibre non-linear loop mirror suitable for use in the regenerator of FIGS. 1 and 2;

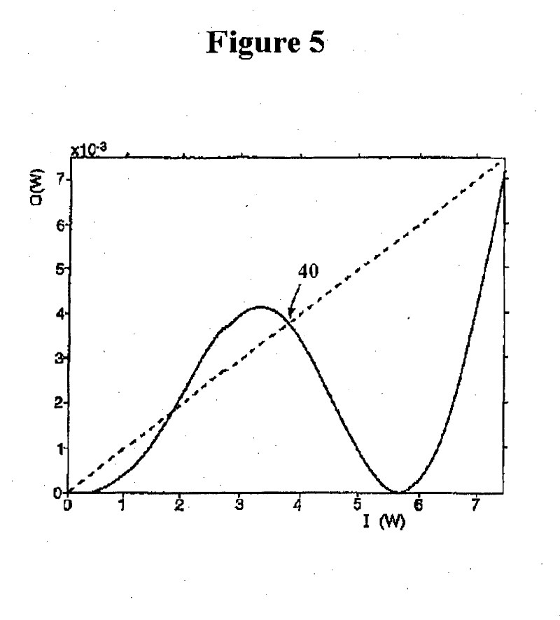

FIG. 5 is a graph showing the continuous wave switching curve of the non-linear loop mirror of FIG. 4;

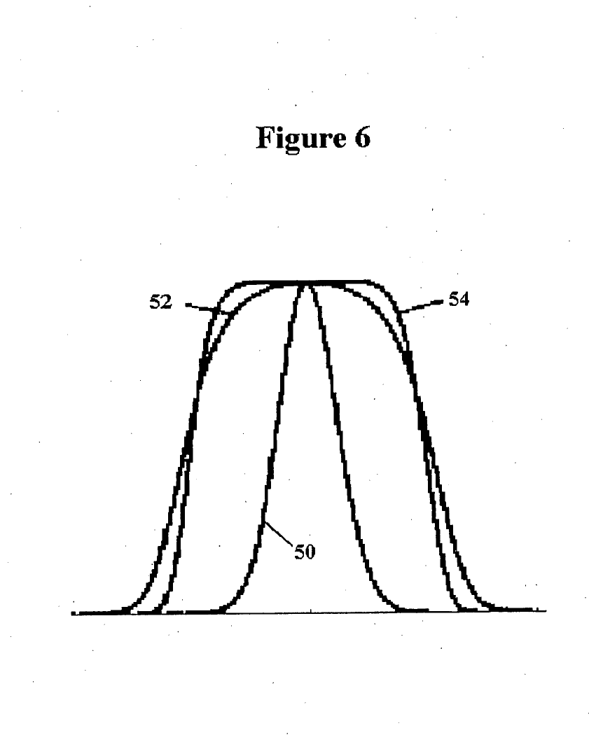

FIG. 6 is a schematic illustrative view of pulse shapes at discreet stages of transmission through the regenerator;

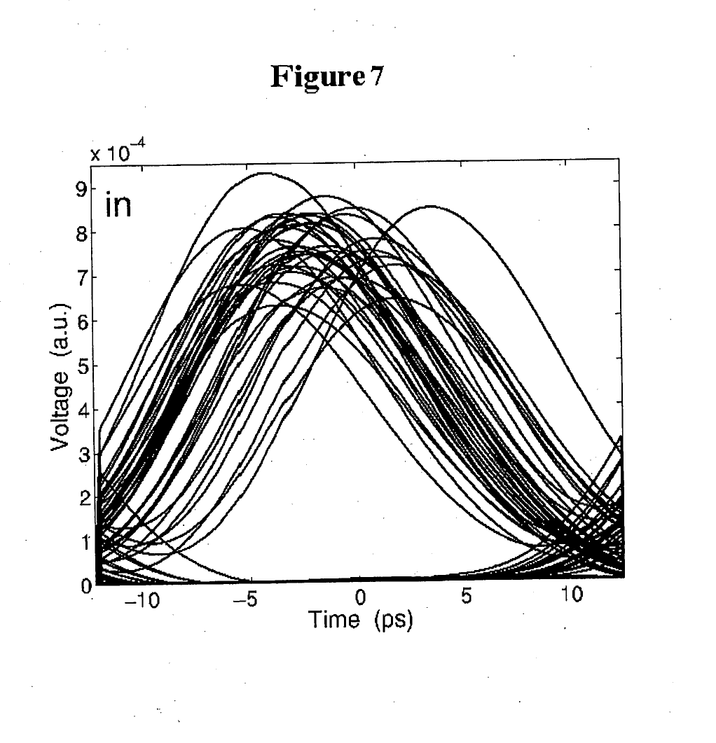

FIG. 7 is a graph illustrating the eye-diagram of an optical data signal at the regenerator input in an optical pulse regenerator according to the invention;

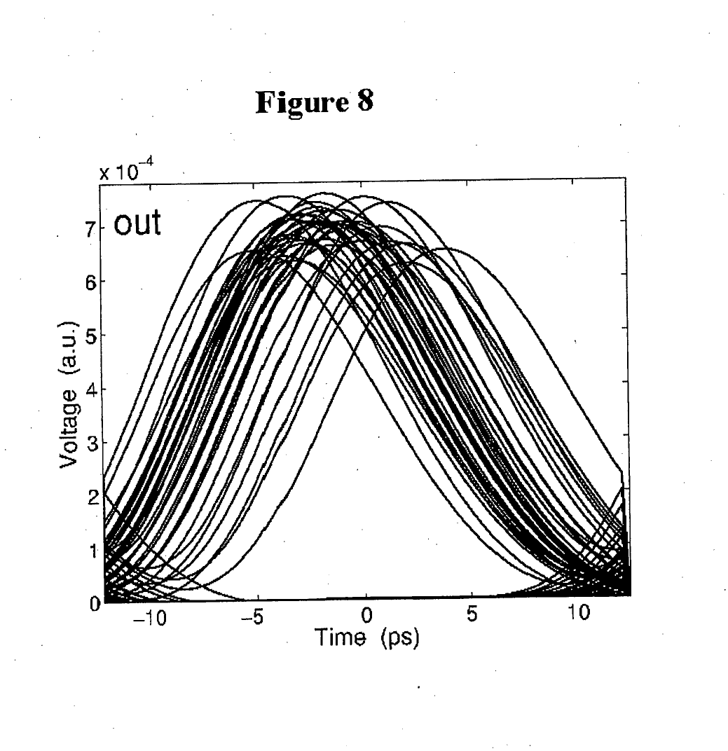

FIG. 8 is a graph illustrating the eye-diagram of the optical data signal of FIG. 7 at the output of a conventional non-linear loop mirror-based optical pulse regenerator (without normal dispersion fibre);

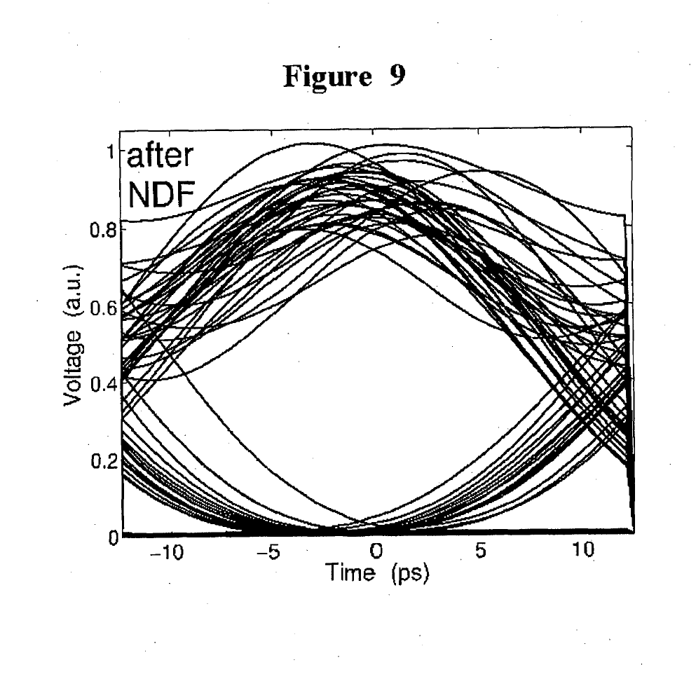

FIG. 9 is a graph illustrating the eye-diagram of the optical data signal of FIG. 7 at the normal dispersion fibre output in an optical pulse regenerator according to the invention;

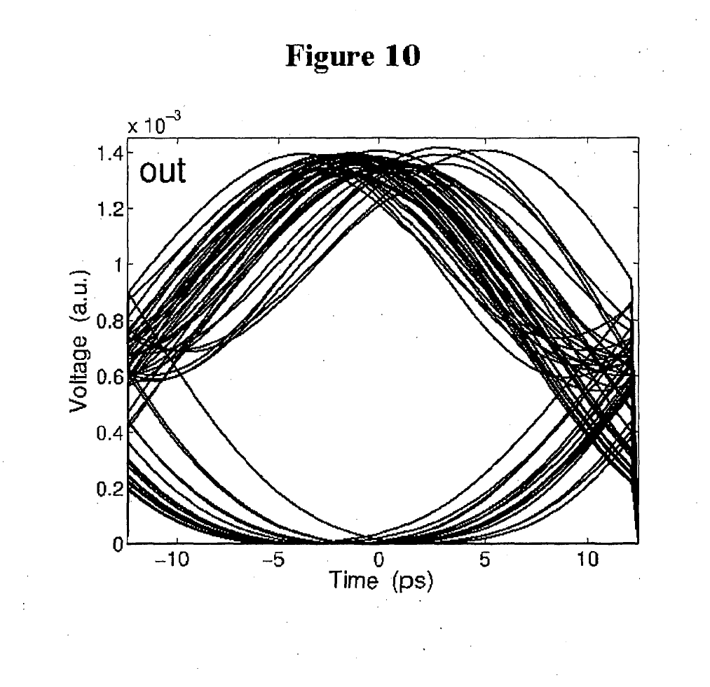

FIG. 10 is a graph illustrating the eye-diagram of the optical data signal of FIG. 7 at the regenerator output in an optical pulse regenerator according to the invention;

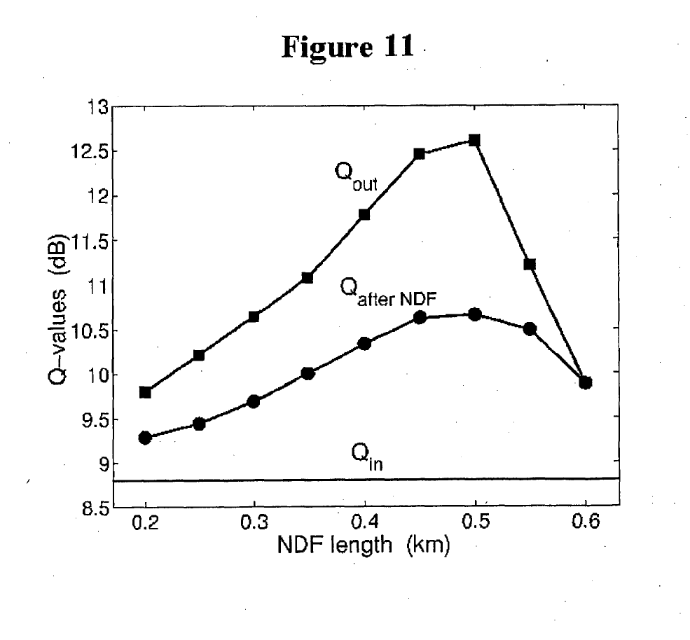

FIG. 11 is a graph illustrating the dependence of the Q-factor at the regenerator input, at the normal dispersion fibre output and at the regenerator output on the length of the normal dispersion fibre, in an optical pulse regenerator according to the invention; and

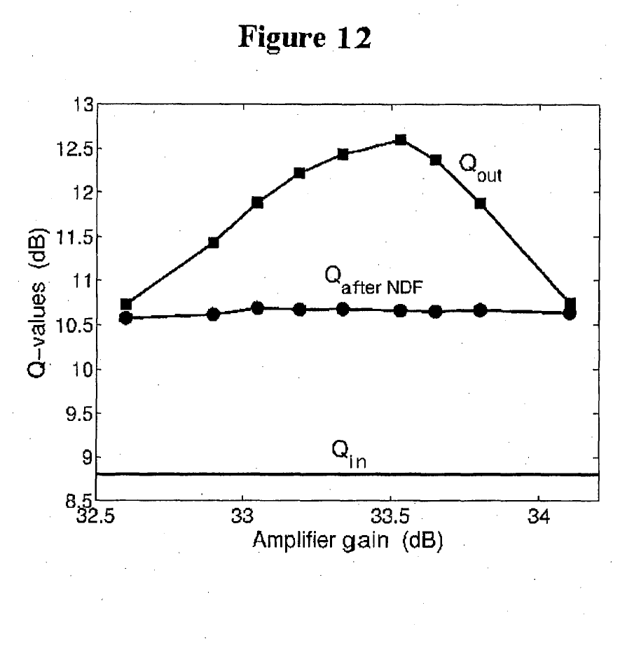

FIG. 12 is a graph illustrating the dependence of the Q-factor at the regenerator input, at the normal dispersion fibre output and at the regenerator output on the gain of the optical amplifier, in an optical pulse regenerator according to the invention.

Referring to FIG. 1 there is shown an optical pulse regenerator 10 comprising an optical amplifier 12, a section of normal dispersion fibre (NDF) 14 and a non-linear optical loop mirror (NOLM) 16. All three components are located in between an input 18 located nearest the amplifier 12 and output 20 located downstream of the NOLM 16. Point 22 constitutes both the output from the NDF 14 and the input for the NOLM 16. The amplifier 12 in this example is a lumped erbium-doped fibre amplifier (EDFA).

Referring to the regenerator 10, the EDFA 12 has a noise figure of 4.5 dB.

Referring to the regenerator 10, the NDF 14 in this example has a dispersion coefficient of −20 ps/(nm km), an effective area of 30 μm² (corresponding to a non-linear coefficient of 4.3 (W km)⁻¹)) and an attenuation of 0.24 dB/km.

Referring to the regenerator 10 or 110, the NOLM 16 in these examples is an absorption non-linear loop mirror. In FIG. 4, the NOLM 16 can be seen to comprise a fibre optic coupler 26, a loop of optical fibre 28, and an absorption element 30. The fibre optic coupler 26 is a 2×2 coupler having a power-splitting ratio of 50:50. The first port 32 of the coupler 26 is connected to the output of the NDF 14, and is therefore directly connected to the NOLM input 22. The second port 34 of the coupler 26 forms the output of the NOLM 16 and therefore is in direct optical communication with the regenerator output 20. The third port 36 and the fourth port 38 of the coupler are connected together via the fibre loop 28.

The absorption element 30 is asymmetrically located within the fibre loop 28, close to the coupler 26. The asymmetric location of the absorption element 30 is required in order to make the NOLM 16 unbalanced. The unbalanced nature of the NOLM 16 ensures that all of the optical pulses entering the NOLM 16, through the input 22, are transmitted by the NOLM 16, through port 34 to the regenerator output 20.

Referring in particular to the regenerator 10, the NOLM fibre loop 28 in this example is a loop of dispersion-shifted fibre (DSF), and the DSF has a dispersion coefficient of 0 ps/(nm km), an effective area of 25 μm² and an attenuation of 0.3 dB/km. The length of the fibre loop 28 is 1.5 km.

In FIG. 2 there is shown a second embodiment of an optical pulse regenerator 110. The optical regenerator 110 comprises a NOLM 16, a section of NDF 14, an input 18 and an output 20 as with the regenerator 10. However, instead of the EDFA 12 the optical amplifier is instead a distributed Raman fibre amplifier 112. The NDF 14 is used as the amplifying medium where the signal, propagated together with a pump wave, is amplified through the stimulated Raman scattering process.

As depicted in FIG. 2, the Raman amplifier is bi-directionally pumped by the forward pump 113 and the backward pump 115 located on opposite sides of the NDF 14. Point 22 is located after the backward pump and therefore constitutes the output from the combined amplifier 112 and NDF 14 section. Alternatively the pumping could be realised in a single direction, either co-directionally with the propagating signal or counter-directionally and accordingly may have one pump.

FIG. 3 shows the evolution of the intensity profile of an optical pulse with the propagation distance in a NDF with distributed Raman amplification. The distributed fibre amplifier of FIG. 3 is suitable for use with the NDF 14 of the optical pulse regenerator 110. The pulse depicted in FIG. 3 was sent through a NDF with a dispersion coefficient of −27.5 ps/(nm km), a non-linear coefficient of 6 (W km)⁻¹, a length of 4 m and an integrated gain of 25 dB. The gain distribution is substantially constant along the fibre, which corresponds to bidirectional pumping. The input pulse at distance 0 m is a Gaussian-shaped pulse with a full width at half-maximum (FWHM) of 0.5 ps and energy of 70 pJ. As the incident pulse is amplified to high intensity, it evolves into a parabolic-shaped pulse after some initial transition stage. In this example, the asymptotic parabolic regime occurs after a propagation distance of 2.5 m. The asymptotic parabolic pulse then propagates self-similarly in the NDF.

FIG. 5 shows the continuous wave relationship between the input power I (W), in Watts, of the NOLM 16 to its output power 0 (W). The power loss of the loop absorption element 30 in this example is −27.1 dB. The NOLM 16 is preferably operated in the region 40 just after the first peak of the switching curve. By operating the NOLM 16 in the region 40 of the switching curve, any change in the input power to the NOLM 16 results in a smaller negative change in the output power from the NOLM 16. The output power from the NOLM 16 is therefore substantially stable against small changes in the input power.

The power level of an optical pulse entering the optical regenerator 10 or 110 at the input 18 will generally be different from the power level at which optimum performance of the regenerator is achieved. The preferred power level of the regenerator 10 or 110 depends essentially on the power level at the NOLM input 22 because the NOLM 16 is a device with a power decision action. The power level at the NOLM input 22 should preferably be such that to operate the NOLM 16 in the stable region 40 of the switching curve. The preferred power level of the regenerator 10 or 110 in these examples is greater than the power level at the regenerator input 18. The input pulses to the regenerator 10 or 110 are therefore amplified to the preferred power level of the regenerator by the amplifier 12 or 112. Also, amplification of the optical pulses in input to the regenerator 10 or 110 by the amplifier 12 or 112 enhances the Kerr non-linearity in the NDF 14.

In use pulses are transmitted from the input 18 through the NDF 14 then through the NOLM 16 and to the output 20. During transmission through the regenerator 10 or 110 the pulses are altered in profile. In FIG. 6 is shown an illustrative schematic view of the pulse profiles 50, 52 and 54 at the input 18, at the NDF output 22 and at the output 20, respectively, in the regenerator 10.

Referring to FIG. 6, during transmission along the NDF 14, the temporal waveform of the optical pulse 50 changes to a rectangular-like profile 52 by the combined action of group-velocity dispersion and Kerr non-linearity. In the regenerator 110 the temporal waveform of the pulse may also be changed to a parabolic profile by dispersion, non-linearity and gain in the NDF 14, as the example of FIG. 3 shows. After propagation in the NDF 14, the pulse width is broadened and the center portion of the pulse changes to be flat. By utilising this property in order to broaden the pulse width correctly, the phase margin of a return-to-zero (RZ) optical data signal can be improved. The phase margin improvement enables reduction of the influence of the displacement of pulse position in time caused by timing jitter.

Following the NDF 14, the optical pulse transmits through point 22 and enters the NOLM 16. Since the NOLM 16 is unbalanced, it acts as a saturable absorber and hence filters out low-intensity noise and dispersive waves from the higher-power pulse. This allows for restoration of the pulse amplitude and shape (2R regeneration). Also, whenever the NOLM 16 operates in the region 40 after the switching peak, it enables stabilisation of amplitude fluctuations. When a pulse train enters the NOLM 16, the noise and radiative background in the zero timing slots is suppressed by the saturable absorption action of the NOLM 16, and the amplitude jitter of ones is also reduced. The pulse profile is changed from profile 52 to resembling profile 54.

A qualitative idea of the main degrading factors of the quality of a signal can be obtained from a signal eye-diagram. Such eye-diagrams are formed by superposing pulses corresponding to different timing slots in a pulse train on top of each other FIGS. 7-12 illustrate the performance of the regenerator 10 in terms of eye-diagrams and Q-values. To create the diagrams of FIGS. 7-12, the efficiency of the regenerator 10 is demonstrated by its application to 40 Gbit/s RZ optical data streams. 2⁷⁻¹ pseudo-random RZ single-channel pulse trains are transmitted at 40 Gbit/s in a dispersion-managed system whose transmission performance is severely degraded by intra-channel non-linear effects when regenerators are not used. In such a system, the periodical deployment in-line of NOLMs effectively stabilises the accumulation of pulse distortion and amplitude noise driven mainly by the intra-channel four wave mixing, and the transmission distance is limited by the timing jitter induced by the intra-channel cross-phase modulation. This presents a good model situation to demonstrate the action of the optical regenerator 10. The pulses after 20000 km transmission are used at the input 18 of the regenerator 10. The input pulse energy and FWHM pulse width are approximately 0.011 pJ and 7 ps, respectively.

FIGS. 7, 8, 9 and 10 show examples of eye-diagrams at the regenerator input 18, at the output of a conventional NOLM-based regenerator (without NDF), at the NDF output 22 and at the regenerator output 20, respectively. The eye-diagrams are generated from single simulations. In these examples, the power gain of the EDFA 12 is 33.5 dB, the length of the NDF 14 is 0.5 km, the power loss of the loop absorption element 30 in the NOLM 16 is −27.1 dB and a fourth-order Bessel-Thomson filter with a cut-off frequency of 30 GHz is used here as a receiver low-pass filter.

In FIG. 7 is shown the eye-diagram at the input 18. It can be seen that the “eye” is “closed” that is that the eye opening (the area in the centre of the pulse) is relatively small. This is mainly due to the significant timing jitter of the optical pulses, indeed the positions of the peaks in the pulses can be seen to vary quite considerably along the time axis.

In FIG. 8 is shown the eye-diagram at the output of a conventional NOLM-based regenerator that does not use a NDF. It can be seen that the eye is still closed and timing jitter is still present indicating that conventional NOLM regenerators do not aid problems caused by timing jitter.

In FIG. 9 is shown the eye-diagram at the NDF output 22. It can be seen that the pulse duration has been broadened. In this example the FWHM pulse width has been broadened to approximately 25 ps. Simultaneously, the pulse shape has been flattened. Consequently, the eye opening has become larger after propagation in the NDF 14. It can also be seen that the amplitude jitter of pulses at the centre of the timing slot is slightly smaller than at the input 18 (FIG. 7).

In FIG. 10 is shown the eye-diagram at the output 20. At the output 20 the eye opening is wider still due to the significant reduction of amplitude jitter provided by the NOLM 16.

In order to characterise and optimise an optical regeneration scheme it is preferable to investigate the impact of intrinsic regenerator parameters on the regenerator performance. The tolerance margins of the regenerator 10 response to variations in the regenerator parameters are set here by requiring that the Q-value at the regenerator output 20 is larger or equal to the Q-value at the NDF output 22, which itself is larger or equal to the Q-value at the regenerator input 18.

The quality of the optical signals being transmitted through an optical regenerator is generally evaluated in terms of a standard Q-factor, where a Q of 7.8 dB (corresponding to a linear Q of 6) is equivalent to a bit error rate (BER) of 10⁻⁹. The Q-value is the ratio of the separation of adjacent pulses in a pulse train to the variance in the position of an individual pulse within its timing slot. It is to be understood that, as usually in systems with regeneration (and thus with a power decision level), here the Q-factor is used as a characteristic of the eye quality rather than an estimate of the BER.

A key parameter to be tuned in the regenerator 10 is the length of the NDF 14. In FIG. 11 is shown the dependence of the Q-factor at the NDF output 22, Q_{after NDF}, and at the regenerator output 20, Qₒᵤₜ, on the length of the NDF 14. For comparison the Q-factor at the regenerator input 18, Qᵢₙ, is shown, which is of course completely independent of the length of the NDF 14 (or any other regenerator parameter). In this example the loss of the loop absorption element 30 in the NOLM 16 is set to be −27.1 dB, and in each case the gain of the EDFA 12 is adjusted to provide adequate power at the NOLM input 22 and adequate enhancement of the nonlinearity in the NDF 14. It is seen in FIG. 11 that the regenerator 10 in this example works with NDF 14 lengths between 0.2 and 0.6 km, and for the optimum length of 0.5 km it improves the signal quality by 3.8 dB (corresponding to a linear improvement factor of 2.4). For this NDF 14 length the pulse energy at the NOLM input 22 is approximately 25.1 pJ.

The decrease of Q_{after NDF} for lengths shorter than the optimum one is due to less pulse broadening and flattening by non-linearity and dispersion in the NDF 14. For lengths longer than the optimum one, the pulse width after propagation in the NDF 14 is broadened appreciably beyond the timing slot, and therefore this also results in a decrease of Q_{after NDF}. The variation of Qₒᵤₜ with the NDF length indicates that the range of allowed NDF 14 lengths is mainly determined by the NOLM 16. For NDF 14 lengths shorter/longer than the optimum one the power level of pulses at the NDF output 22 is greater/smaller than the correct power level for the NOLM 16 to operate in the region 40. The correct power level at the NOLM input 22 could be achieved by reduction/increase of the EDFA 12 gain. But a lower/higher gain of the EDFA 12 would diminish/enhance further the effect of non-linearity in the NDF 14, and therefore such an adjustment would result in a significant deterioration of the signal quality at the output 22.

The tolerance of the regenerator 10 to the variations in the gain of the EDFA 12 for a fixed NDF 14 length should be fixed. In FIG. 12 is shown the Q-factor at the NDF output 22 and the regenerator output 20 as a function of the amplifier 12 gain in dB, when the length of the NDF 14 is set to its optimum value of 0.5 km. Again, the Q-factor at the regenerator input 18 is also shown for reference. It can be seen that the Q-factor at the output 22 varies very little with the amplifier 12 gain in the considered range of gains. But the Q-value at the regenerator output 20 does vary appreciably because of the sensitiveness of the NOLM 16 to the power level at its input 22. In this example the optimum value of the amplifier 12 gain is 33.5 dB, which corresponds to a pulse energy at the NOLM input 22 of approximately 25.1 pJ (as for FIG. 11). For gain deviations of +0.5 and −0.5 dB from the optimum value, which corresponds to variations of +6.4 and −10.4% in the pulse energy at the NOLM input 22, the Q-factor at the regenerator output 20 is at least 3 dB higher than the Q-factor at the regenerator input 18.

The optical pulse regenerator according to the invention, which has been particularly described through its embodiment 10, therefore provides an all-optical regeneration technique that combines the intensity filtering action of a saturable absorber for achieving 2R regeneration of the optical signals with broadening of the temporal widths of optical pulses and simultaneous flattening of the centre portions of pulses for improvement of the signal phase margin. The application of the regenerator 10 and 110 therefore provides both suppression of noise and radiative background in the zero timing slots of optical signals and reduction of the amplitude jitter of ones, and reduction of the impact of timing jitter without increasing the intersymbol interference.

The design of the optical pulse regenerator according to the invention does not depend on the particular transmission scheme to which the regenerator is applied. Although the operation of the regenerator with single-channel optical data signals is particularly described, the regenerator may be used in transmission systems employing wavelength-division multiplexed data signals by applying the regenerator after signal demultiplexing.

Even though the application of the optical pulse regenerator in transmission systems is particularly described, the regenerator can also be used as an optical regenerating component of an optical RZ receiver. In this instance, the optical regenerating component is desirably placed in front of the detector, to improve the optical signal quality before detection.

The optical pulse regenerator can also be used as an optical pulse shaper for transferring RZ pulses to non-return-to-zero (NRZ)-like pulses. In this instance, the transfer of RZ pulses to NRZ-like pulses occurs thorough broadening of the pulses' temporal widths and simultaneous flattening of the centre portions of pulses. The NRZ-like pulses may have a rectangular-like temporal profile such as the profile 52 in FIG. 6, or alternatively a parabolic temporal profile such as shown in FIG. 3.

Different types of optical fibres may be used in the optical regenerator. The NDF may be any optical fibre having a negative dispersion coefficient, that is the magnitudes of its dispersion, non-linearity, and attenuation parameters may be any. For a fixed amount of pulse amplification by the optical amplifier in the regenerator, the trade-off between the effects of dispersion, non-linearity and attenuation in the NDF determines the adequate NDF length for suitable power level at the NOLM input. Furthermore, the DSF in the NOLM fibre loop may be replaced by a different type of optical fibre. Furthermore, it will be understood that the length of the NOLM fibre loop is determined in terms of the input power to the NOLM, and therefore may be tuned provided that the gain of the optical amplifier and the NDF length are changed accordingly.

Although an optical fibre non-linear loop mirror is specifically described, the loop mirror may alternatively comprise, in full or in part, a semiconductor waveguide device. An absorption loop mirror is described, but it will be understood that an alternative type of loop mirror, such as an amplifying loop mirror comprising an optical amplifier asymmetrically located within the fibre loop, a dispersion unbalanced loop mirror, or an unbalanced coupler loop mirror, may be used with consequent changes to the optical regenerator.

1. An optical pulse regenerator comprising: an optical pulse reshaper for broadening temporal widths and flattening center portions of an optical pulse;
a saturable absorber coupled to the optical pulse reshaper; and
an optical amplifier coupled to the optical pulse reshaper.

2. An optical pulse regenerator according to claim 1, where the optical pulse reshaper includes a section of normal dispersion fiber.

3. An optical pulse regenerator according to claim 2 wherein the section of normal dispersion fiber has a negative dispersion coefficient.

4. An optical pulse regenerator according to claim 1 wherein the saturable absorber includes an unbalanced optical interferometer.

5. A regenerator according to claim 1, wherein, for a defined amount of pulse amplification by the optical amplifier, the adequate length of the normal dispersion fiber for a suitable power level at a fiber output is determined by the trade-off between the effects of dispersion, non-linearity and attenuation in the fiber.

6. A regenerator according to claim 1, wherein the unbalanced interferometer is a Sagnac interferometer.

7. A regenerator according to claim 6, wherein the interferometer is a non-linear loop mirror.

8. A regenerator according to claim 7, wherein the non-linear loop mirror comprises a 2×2 optical coupler, a first port on one side of the coupler forming an input to the non-linear loop mirror, a second port on the one side forming an output to the non-linear loop mirror, and ports on another side of the coupler being connected together by a section of optical waveguide, to form a waveguide loop.

9. A regenerator according to claim 8, wherein the optical coupler is one of the following: a fiber optic coupler and a semiconductor waveguide device, and the optical waveguide comprises at least one of the following: a section of the optical fiber and a section of semiconductor waveguide.

10. A regenerator according to claim 7, wherein the non-linear loop mirror is one of the following:
an absorption non-linear loop mirror, comprising an absorption element asymmetrically located within a fiber loop:
an amplifying non-linear loop mirror, comprising an optical amplifier asymmetrically located within a fiber loop:
a dispersion unbalanced non-linear loop mirror: and
an unbalanced coupler non-linear loop mirror.

11. A regenerator according to claim 7, wherein the non-linear loop mirror operates within a region of its switching curve in which the output power of the non-linear loop mirror is substantially stable against small changes in output power from the optical pulse reshaper.

12. A regenerator according to claim 11, wherein the non-linear loop mirror operates in a region after a first peak of its switching curve.

13. A regenerator according to claim 7, wherein the optical amplifier adjusts pulse power to a level for input to the saturable absorber which is after a first peak of its switching curve of the non-linear loop mirror.

14. A regenerator according claim 7, wherein a loop length of the non-linear loop mirror is determined in terms of input power to the non-linear loop mirror.

15. A regenerator according to claim 7, wherein the non-linear loop mirror comprises a loop of dispersion-shifted fiber.

16. A regenerator according to claim 1, wherein the optical amplifier is a lumped erbium-doped fiber amplifier or a distributed Raman fiber amplifier.

17. A regenerator according to claim 16, wherein the optical pulse reshaper includes a section of normal dispersion fiber which acts as an amplifying medium.

18. A regenerator according to claim 17, wherein the distributed Raman fiber amplifier is one of the following:
bi-directionally pumped by a forward pump and a backward pump; or
pumped with one pump in a single direction, which is one of the following:
co-directionally with a propagating signal; and
counter-directionally.

19. A regenerator comprising:
a saturable absorber that provides intensity filtering for achieving 2R regeneration of an optical signal; and
a normal dispersion fiber that provides broadening of temporal widths and flattening of center portions of an optical pulse for improvement of signal phase margin.

20. A regenerator according to claim 19, wherein the optical signal comprises an optical communication signal, and wherein the regenerator provides:
suppression of noise and radiative background in zero timing slots of the optical communication signal and reduction of amplitude jitter of ones, and
reduction of the impact of timing jitter without increasing intersymbol interference.

21. A regenerator according to claim 20 wherein the optical communication signal comprises one of the following: a single-channel optical data signal and a wavelength-division multiplexed data signal.

22. A regenerator according to claim 21, wherein the optical communication signal is received from an optical transmission system after signal demultiplexing.

23. An optical pulse regenerator according to claim 1, where in the optical pulse regenerator is within an optical return-to-zero receiver.

24. An optical pulse regenerator according to claim 23, wherein the optical pulse regenerator performs signal quality regeneration before detection.

25. An optical pulse shaper comprising:
an optical pulse reshaper for broadening temporal widths and flattening center portions of an optical pulse in optical communication, and enabling transfer of return-to-zero optical pulses to non-return-to-zero-like pulses;
a saturable absorber coupled to the optical pulse reshaper; and
an optical amplifier coupled to the optical pulse reshaper.

26. An optical pulse shaper according to claim 25, wherein the optical pulse reshaper includes a section of normal dispersion fiber.

27. An optical pulse reshaper according to claim 26, wherein the section of normal dispersion fiber has a negative dispersion coefficient.

28. An optical pulse shaper according to claim 25, wherein the transfer of return-to-zero pulses to non-return-to-zero-like pulses occurs through broadening of the temporal widths and flattening of the centre portions of the pulses produced by dispersion and non-linearity in a the normal dispersion fiber.

29. An optical pulse shaper according to claim 25, which produces non-return-to-zero-like pulses having a rectangular-like temporal profile or a parabolic temporal profile.

30. A regenerator according to claim 19, further comprising a housing containing the saturable absorber and the normal dispersion fiber.

31. A method of regenerating a signal of optical pulses comprising;
amplifying the pulse power of the signal,
transmitting the signal through a section of fiber with negative dispersion coefficient to broaden the widths and flatten the centers of the pulses through dispersion and Kerr non-linearity and
transmitting the amplified broadened and flattened signal through a saturable absorber comprising an unbalanced non-linear optical loop mirror to reduce pulse distortion and amplitude noise.

32. The method of claim 31, further comprising using an unbalanced interferometer and the fiber with negative dispersion coefficient to reduce the effects of pulse distortion, amplitude noise and timing jitter in regenerating the signal.
